(19) United States
(12) Patent Application Publication
(10) Pub. No.: US 2026/0145111 A1
(43) Pub. Date: May 28, 2026

(54) AIR SCRUBBER

(71) Applicant: GLOBAL INDUSTRIAL DISTRIBUTION INC., Port Washington, NY (US)

(72) Inventors: Richard B. LEEDS, Port Washington, NY (US); Bruce B. ZUTLER, Port Washington, NY (US); Phillip LEE, Port Washington, NY (US)

(73) Assignee: GLOBAL INDUSTRIAL DISTRIBUTION INC., Port Washington, NY (US)

(21) Appl. No.: 18/960,703

(22) Filed: Nov. 26, 2024

(51) Int. Cl. B01D 46/64; B01D 46/00; B01D 46/42; B01D 46/44; B01D 46/52

(52) U.S. Cl. CPC B01D 46/64; B01D 46/0086; B01D 46/4245; B01D 46/44; B01D 46/521; B01D 2267/40; B01D 2273/30

(57) ABSTRACT

An air scrubber comprises a body configured to fit through most doorways. The air scrubber can produce an air flow of at least 2400 cubic feet per minute while having a width small enough to fit through a standard doorway.

### FIELD

The present invention relates to an air scrubber for filtering air.

### BACKGROUND

Industrial air scrubbers capable of filtering air at high rates are typically bulky and may be too large to fit through a standard doorway. Smaller and more portable air scrubbers may be easier to transport and fit through a doorway, but are unable to filter air at higher rates.

A need exists for a portable air scrubbing device capable of filtering air at rate of at least 2400 cubic feet per minute. Embodiments of the present disclosure are directed to this and other considerations.

### SUMMARY

An air scrubber is disclosed. According to some examples, the body of the air scrubber is configured to fit through a standard doorway. The air scrubber produces at least 2400 cubic feet per minute of air flow. In some examples, the body of the air scrubber is substantially rectangular. The body of the air scrubber may have a width of about 24 inches. The air scrubber may have a depth approximately equal to the width. The body of the air scrubber may have a height of approximately 43.5 inches.

In some examples, the air scrubber has four side faces, each side face includes an access door configured to access at least one filter. The air scrubber may include a first filter and a second filter provided between a filter grate and an access door on each face of the air scrubber. In some examples, the first filter is a pleated filter and the second filter is a high efficiency particulate air (HEPA) filter.

In some examples, the air scrubber includes an exhaust positioned on a top face of the body and each door of the four side faces is configured as an air intake. A fan is housed within the body of the air scrubber and arranged to draw air through the four side faces and exhaust air through the exhaust on the top face. The air scrubber may further include four casters.

In some examples, the air scrubber further includes a control panel. The control panel may include an auxiliary power outlet. The auxiliary power outlet may be used to daisy chain an additional two air scrubbers of the same type. The air scrubber can be powered by a standard wall outlet at 15 amperes and 115 volts. In some examples, the current provided by the auxiliary power outlet of the air scrubber varies to provide 12 amperes when the air scrubber is turned off, and about 9 amperes when the air scrubber is operating. The control panel may include a speed control. At the lowest setting the speed control may switch the air scrubber off. The control panel may include a filter change indicator light. The air scrubber may operate at approximately 75 decibels or less.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a front perspective view of an air scrubber, according to certain embodiments of the present disclosure.

FIG. 2 is a front view of the air scrubber, according to certain embodiments of the present disclosure.

FIG. 3 is a detailed view illustrating a control panel of the air scrubber, according to certain embodiments of the present disclosure.

FIG. 4 is a right side perspective view of the air scrubber, according to certain embodiments of the present disclosure.

FIG. 5 is a top perspective view of the air scrubber, according to certain embodiments of the present disclosure.

FIG. 6 is a top perspective view of the air scrubber, according to certain embodiments of the present disclosure.

FIG. 7 is an exploded perspective view of the air scrubber, according to certain embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

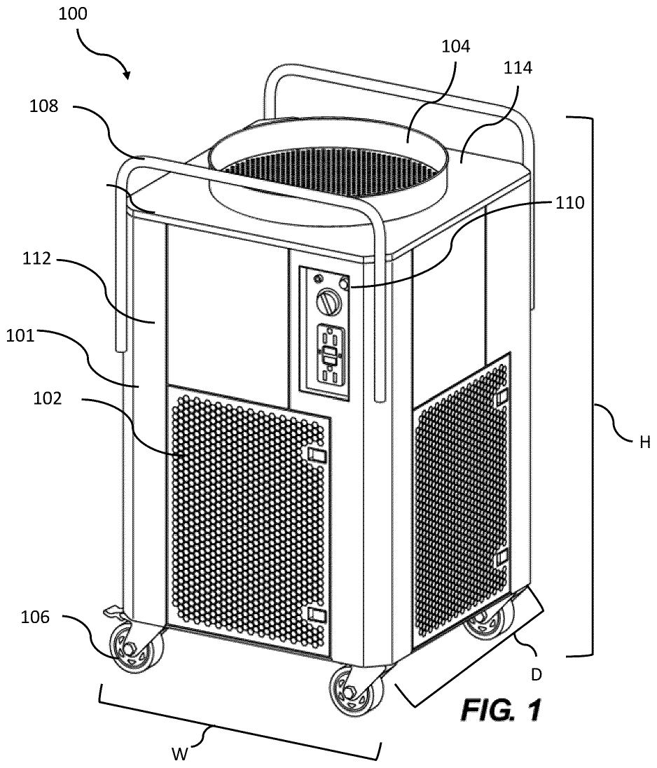

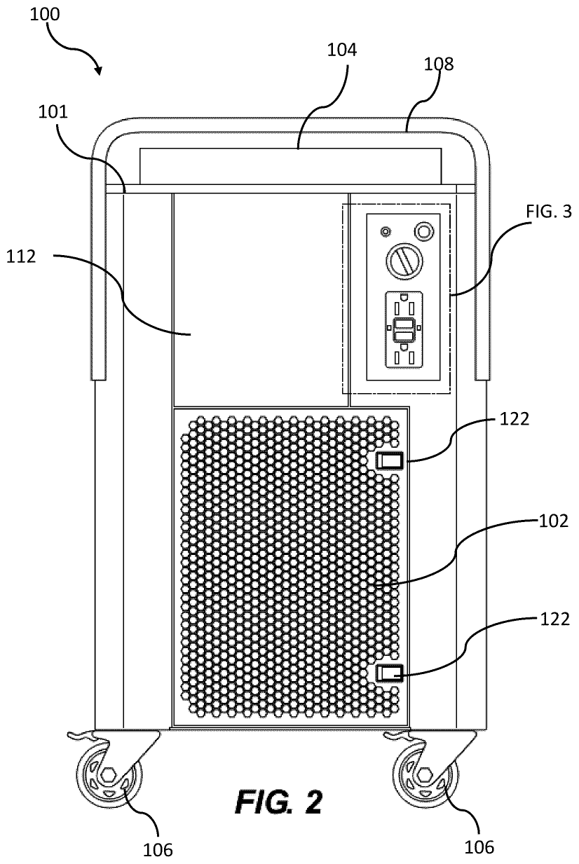

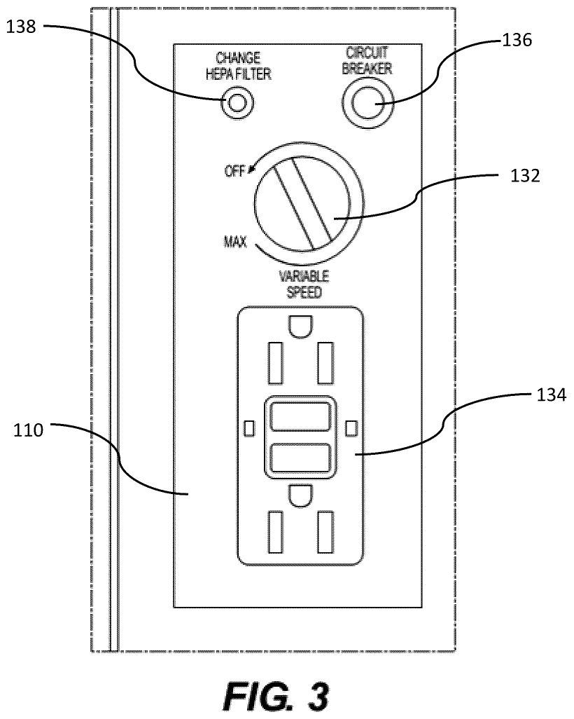

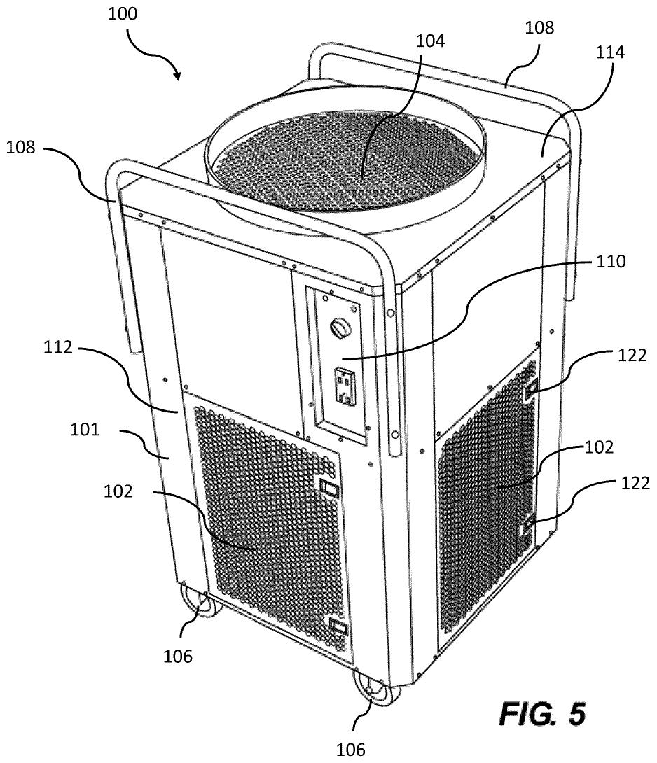

Reference will now be made in detail to exemplary embodiments of the disclosed technology, examples of which are illustrated in FIGS. 1-7, and disclosed herein. Wherever convenient, the same reference numbers will be used throughout the drawings to refer to the same or like parts.

FIGS. 1-7 depict an air scrubber 100 configured to fit through most doorways, according to some examples. In some examples, a body 101 of the air scrubber 100 is substantially rectangular, i.e., having a box-like shape. The typical width for a doorway is about 24 inches (about 61 centimeters) to about 36 inches (about 91.5 centimeters). The body 101 of the air scrubber 100 may comprise a width W of about 24 inches (about 61 centimeters), thereby allowing it to fit through most doorways. The depth D of the body 101 of the air scrubber 100 may be approximately equal to the width W, i.e., the depth D may also be approximately 24 inches. In some examples, the body of the air scrubber 100 has a height H of approximately 43.5 inches (about 110.5 centimeters).

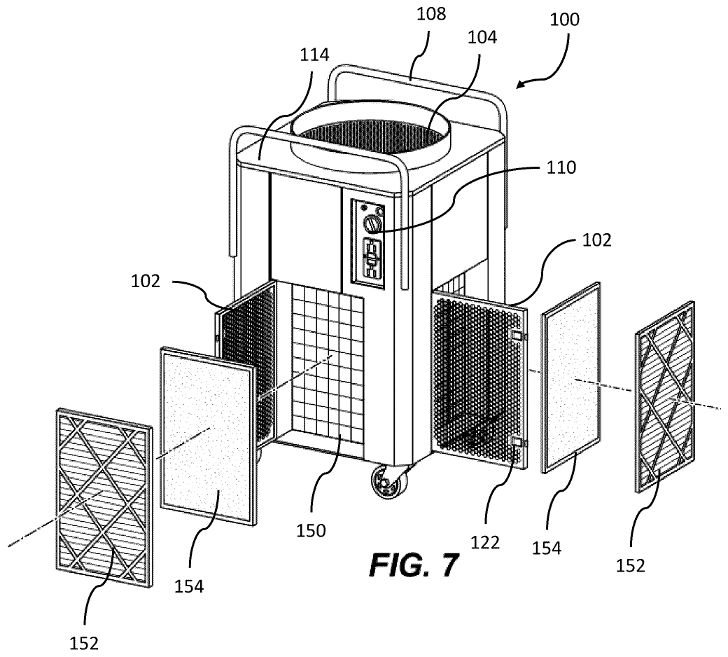

In some examples, the body 101 of the air scrubber 100 comprises four side faces 112. Each side face 112 may comprise an access door 102. The access door 102 may be opened by engaging latches 122. In some examples, as depicted in FIG. 7, filters 152,154 are inserted in a space provided between the access doors 102 and a filter grate 150. In some examples, a first filter 152 comprises a pleated filter, and a second filter 154 comprises a high efficiency particulate air (HEPA) filter. In some examples, the HEPA filter 154 is to be provided interior to the pleated filter 152.

In some examples, a fan (not illustrated) is housed within the body 101. The fan may be arranged to draw air through the four side faces 112 and filters 152,154 and exhaust air through the exhaust 104 on the top face 114. The arrangement allows for the air scrubber 100 to filter air at a rate of more than 2400 cubic feet per minute (CFM) (about 70 cubic meters per minute). In some examples, the air scrubber 100 filters air at a rate of more than 2500 CFM. In some examples, the air scrubber 100 filters air at a rate of more than 3000 CFM. In some examples, the air scrubber filters air at a rate of about 3300 CFM. In some examples, the air scrubber 100 operates at approximately 75 decibels or less.

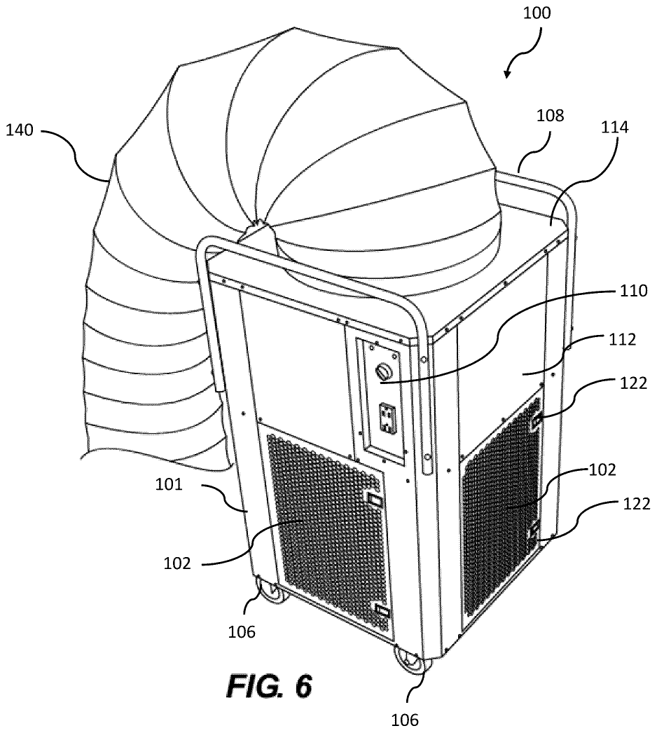

As depicted in FIG. 6, a duct 140 may be attached to the exhaust 104 of the air scrubber 100. In some examples, the exhaust 104 is sized to fit a 20 inch duct. The duct 140 may be used to exhaust air into outside or into another room, thus allowing the air scrubber 100 to function as a negative air machine. Similarly, filtered air from the air scrubber may be exhausted into a room to create a positive air pressure in a room.

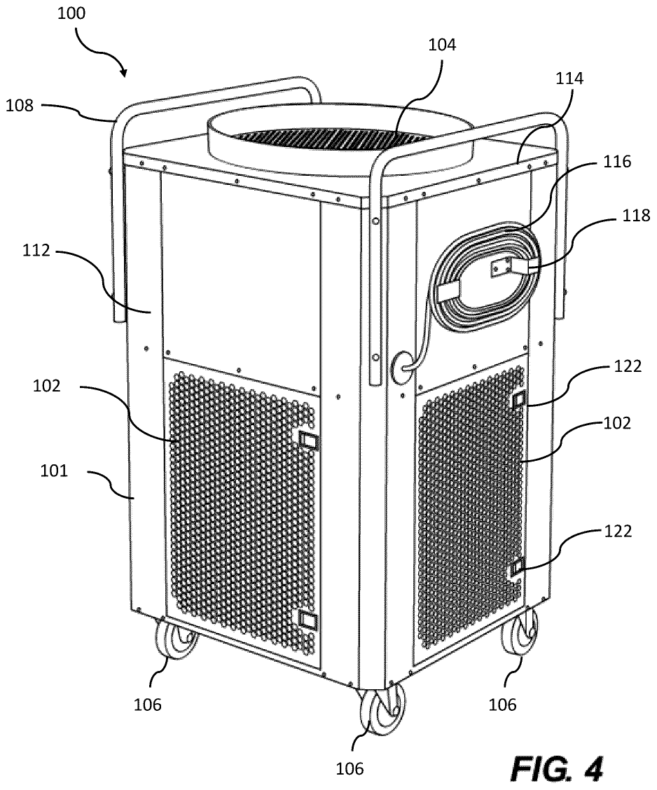

In some examples, the air scrubber 100 is configured to be powered by a standard wall socket providing a power source at 15 amperes and 115 volts. In some examples, the air scrubber 100 is configured to be powered by a standard wall socket providing power at 20 amperes and 115 volts. With reference to FIG. 4, the air scrubber 100 may include a power cord 116. The air scrubber 100 may further include a cord holder 118 to facilitate wrapping a storage of the power cord 116.

In some examples, the air scrubber 100 further comprises a control panel 110. In some examples, the control panel 110 comprises an auxiliary power outlet 134. In some examples, two additional air scrubbers 100 can be powered by daisy chaining via the auxiliary power outlet 134, e.g., a first air scrubber is plugged into a wall socket, a second air scrubber is plugged into the auxiliary power outlet of the first air scrubber, and a third air scrubber is plugged into the auxiliary power outlet of the first air scrubber or into the auxiliary power outlet of the second air scrubber. In some examples, the power provided by the auxiliary power outlet 134 is varied depending on if the air scrubber is operating. For example, the auxiliary power outlet 134 of the air scrubber 100 may provide about 115 volts at 12 amperes when the air scrubber 100 is off, and about 115 volts at 9 amperes when the air scrubber 100 is powered on.

In some examples, the control panel 110 includes a speed control 132. The air scrubber 100 may powered off when the speed control 132 is turned to the lowest position (e.g., if the speed of the fan is increased as the speed control knob is turned clockwise, then the air scrubber is turned off when the speed control knob is in the most counter-clockwise position).

In some examples, the control panel 110 comprises a filter change indicator light 138. The filter change indicator light 138 may illuminate to indicate that the one or more of the filters 152, 154 need to be replaced. Filter wear can be calculated by a number of hours the air scrubber has been operational. The timing of which can be manually reset or based on detecting the opening of one or more of the access doors 102. Alternately, filter wear can be calculated based on a relationship between fan speed and discharge volume. A correlation between fan speed/power draw and volume discharge can be determinate that the filter are clogged and limiting discharge.

The control panel 110 may further include a built-in circuit breaker with a circuit breaker button 136 which may be triggered when an amperage difference (e.g., an amperage difference of about 5 milliamps or more) is detected between the hot and neutral lines. The circuit breaker button 136 may be provided to reset the circuit after the circuit breaker is triggered. Similarly, the auxiliary power outlet 134 may also include a built in circuit breaker with corresponding test and reset buttons.

In some examples, the air scrubber 100 further comprises four casters 106. One or more of the casters 106 may include wheel locks to prevent the air scrubber from rolling. In some examples the air scrubber further comprises handles 108 to facilitate moving of the air scrubber 100. The handles 108 can be configured to be removable.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g., “about 90%” may refer to the range of values from 71% to 99%.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An air scrubber (100) comprising:
a body (101) configured to fit through a standard doorway,
wherein the air scrubber (100) produces at least 2400 cubic feet per minute (CFM) of air flow.

2. The air scrubber (100) of claim 1, wherein the body (101) is substantially rectangular and comprises a width (W) of about 24 inches.

3. The air scrubber (100) of claim 2, wherein the body (101) comprises a depth (D) approximately equal to the width.

4. The air scrubber (100) of claim 3, wherein the body (101) comprises a height (H) of approximately 43.5 inches.

5. The air scrubber (100) of claim 1, wherein the air scrubber (100) is configured to be powered by a power source providing 15 amperes at 115 volts.

6. The air scrubber (100) of claim 1, wherein the body (101) comprises four side faces (112), each side face (112) comprising an access door (102) configured to access at least one filter (152, 154).

7. The air scrubber (100) of claim 6, wherein the at least one filter comprises a first filter (152) and a second filter (154).

8. The air scrubber (100) of claim 7, wherein the first filter (152) comprises a pleated filter, and the second filter (154) comprises a high efficiency particulate air (HEPA) filter.

9. The air scrubber (100) of claim 6, further comprising a filter grate (150), wherein the at least one filter is provided between the access door (102) and the filter grate (150).

10. The air scrubber (100) of claim 6, further comprising an exhaust (104) on a top face (114) of the body (101).

11. The air scrubber (100) of claim 10, wherein each access door (102) of the four side faces (112) is configured as an air intake.

12. The air scrubber (100) of claim 11, wherein a fan is housed within the body (101), the fan arranged to draw air through the four side faces (112) and exhaust air through the exhaust (104) on the top face (114).

13. The air scrubber (100) of claim 1, further comprising four casters (106).

14. The air scrubber (100) of claim 1, further comprising a control panel (110).

15. The air scrubber (100) of claim 14, wherein the control panel (110) comprises an auxiliary power outlet (134).

16. The air scrubber (100) of claim 15, wherein two additional air scrubbers (100) can be powered by daisy chaining via the auxiliary power outlet (110).

17. The air scrubber (100) of claim 14, wherein the control panel (110) comprises a speed control (132).

18. The air scrubber (100) of claim 17, wherein the speed control (132) switches the air scrubber (100) off at a lowest setting.

19. The air scrubber (100) of claim 14, wherein the control panel (110) comprises a filter change indicator light (138).

20. The air scrubber (100) of claim 1, wherein the air scrubber (100) operates at approximately 75 decibels or less.
